(19) United States
(12) Patent Application Publication
(10) Pub. No.: US 2007/0207289 A1
(43) Pub. Date: Sep. 6, 2007

(54) Addition of microspheres to create soft two shot products

(75) Inventors: Glenn A. Cowelchuk, Chesterfield Tw., MI (US); David J. Dooley, Troy, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: Lear Corporation

(21) Appl. No.: 11/368,797

(22) Filed: Mar. 6, 2006

(51) Int. Cl. G11B 5/64

(52) U.S. Cl. 428/141; 428/174

(57) ABSTRACT

A motor vehicle interior trim component comprises a substrate and covering material injection molded onto at least a portion of the substrate. The covering material has gas-encapsulating elements therein. The gas-encapsulating elements have a property of elastic recovery when the gas-encapsulating elements are pressed until they are deformed and then the pressure is relieved. A method for forming the trim component comprises a step of forming a first mold space and injecting a first material into the first mold space so that the first material substantially conforms to the shape of the first mold space to form a substrate. In another step, a second mold space is formed and a second material is injected into the second mold space so that the second material substantially conforms to the shape of the second mold space to form a covering material over the substrate. The second material is softer than the first material and has gas-encapsulating elements therein.

### BACKGROUND OF INVENTION

The present invention generally relates to interior trim components, particularly, for the passenger compartment of a motor vehicle, and a method for producing interior trim components.

The interiors of motor vehicles have a wide variety of trim components, including, for example, pillar linings, door panels, and dashboard covers. It is desirable that such components are soft to the touch, and aesthetically and tactilely pleasing to the vehicle passengers.

It is well known to provide a motor vehicle interior trim component comprised of a substrate covered by a sheet comprised of a urethane resin and elastic beads. The elastic beads have a property of elestci recovery when the beads are pressed until they are deformed and then the pressure is relieved. The sheet is molded on the substrate by vacuum molding or pressure molding. When molded, the sheet is stretched and thus loses its grain depth and definition, and has a glossed up, washed out surface.

### SUMMARY OF INVENTION

The present invention is directed towards a motor vehicle interior trim component comprising a substrate and covering material injection molded onto at least a portion of the substrate. The covering material has gas-encapsulating elements therein. The gas-encapsulating elements have a property of elastic recovery when the gas-encapsulating elements are pressed until they are deformed and then the pressure is relieved.

The present invention is directed towards a method of forming an interior trim component comprising the steps of forming a first mold space and injecting a first material into the first mold space so that the first material substantially conforms to the shape of the first mold space to form a substrate, and forming a second mold space and injecting a second material into the second mold space so that the second material substantially conforms to the shape of the second mold space to form a covering material over the substrate. The second material is softer than the first material and has gas-encapsulating elements therein.

### BRIEF DESCRIPTION OF DRAWINGS

FIG. 1 is a cross-sectional view in side elevation of an interior trim component for a motor vehicle.

FIG. 1A is an enlarged cross-sectional view of a portion of the interior trim component shown in FIG. 1.

FIG. 2 is a cross-sectional view of a first step of a two-shot process for molding the interior trim component.

FIG. 3 is a cross-sectional view of a second step of the two-shot process.

### DETAILED DESCRIPTION

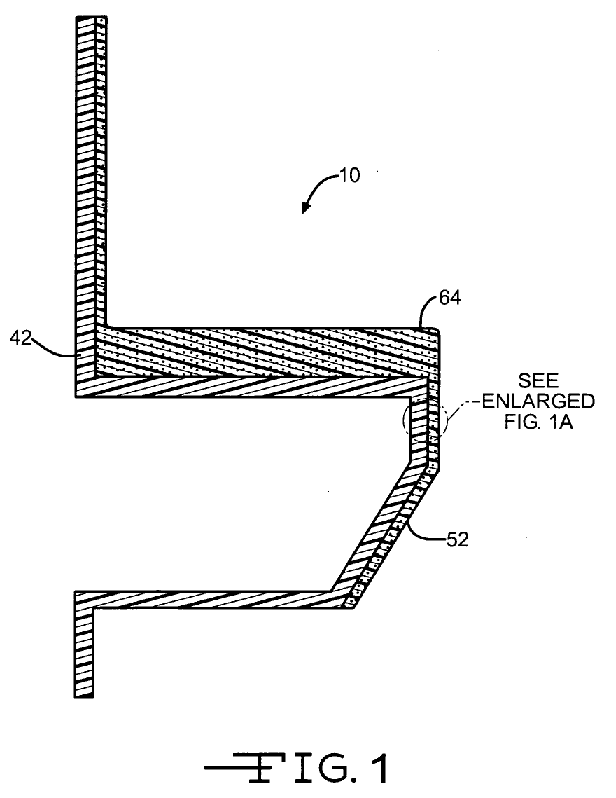

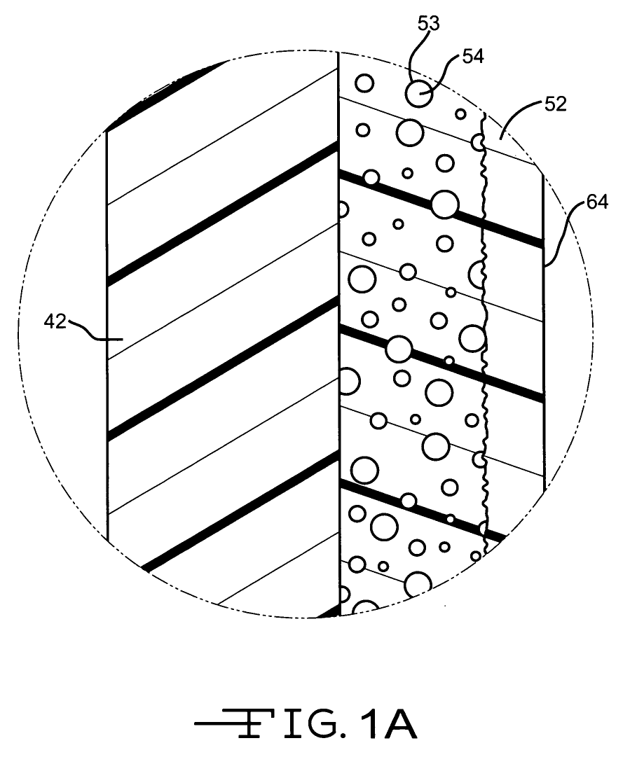

Referring now to the drawings, there is illustrated in FIG. 1 an article in the form of a motor vehicle interior trim component 10. In the exemplary embodiment, the trim component 10 is in the form of an armrest assembly, which is adapted to be mounted to the door trim panel of the motor vehicle, which in turn mounts to the motor vehicle door assembly. It will be appreciated however, that the subject invention is not intended to be limited to the armrest assembly shown but may be any desired motor vehicle interior trim component.

Continuing with reference to FIG. 1, the trim component 10, as illustrated, comprises a substrate 42, preferably formed of rigid plastic, most preferably a thermoplastic, such as a thermoplastic olefin (TPO), or may be formed of a glass reinforced urethane (GRU), a styrene/maleic anhydride copolymer (SMA), or a Dylark (TM) resin, manufactured by NOVA Chemicals, of Calgary, Alberta, Canada, which may be glass reinforced. The substrate 42 may have any desired shape and contour, and has at least a portion that is covered with a covering material 52, which is preferably formed from softer thermoplastic, such as thermo plastic elastomer (TPE), or thermoplastic olefin (TPO), or thermo plastic vulcanite (TPV). The covering material 52 substantially conforms to the shape of a least a portion of the substrate 42 and may be textured so as to create an outer surface or skin 64 for the trim component 10 that is aesthetically and tactilely pleasing. The covering material 52 may be bonded to the substrate 42 during a molding process to form the trim component 10. The bonding may be a chemical bonding, or a mechanical bonding.

As shown in FIG. 1A, the covering material 42 has small particles, such as microspheres (i.e., spherical particles) comprising shells 53 encapsulating gas 54. When the gas 54 is heated, the shells 53 soften to permit a dramatic increase in the volume of the shells 54. When the shell 54 cools, it stiffens and remains in its new expanded shape.

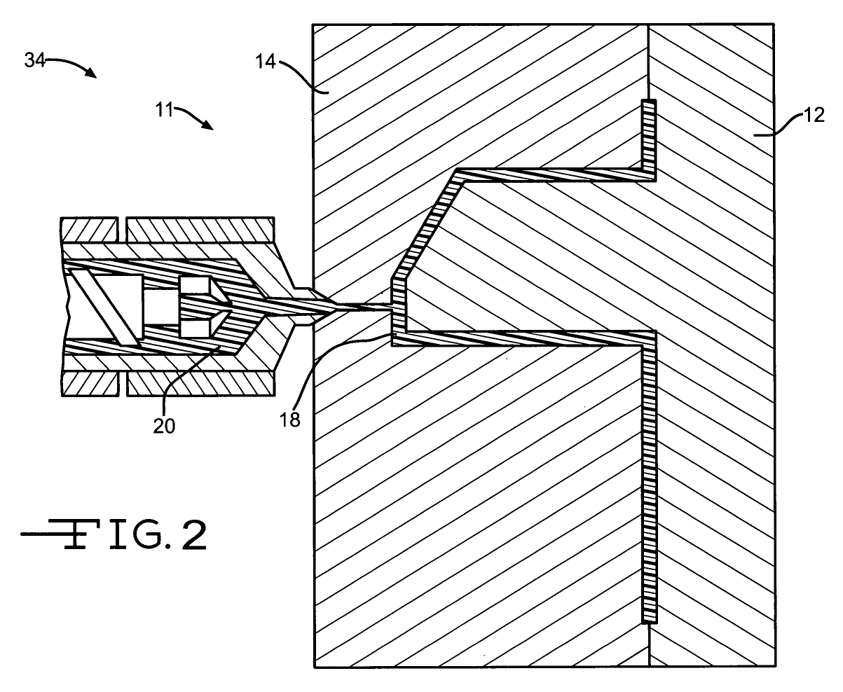

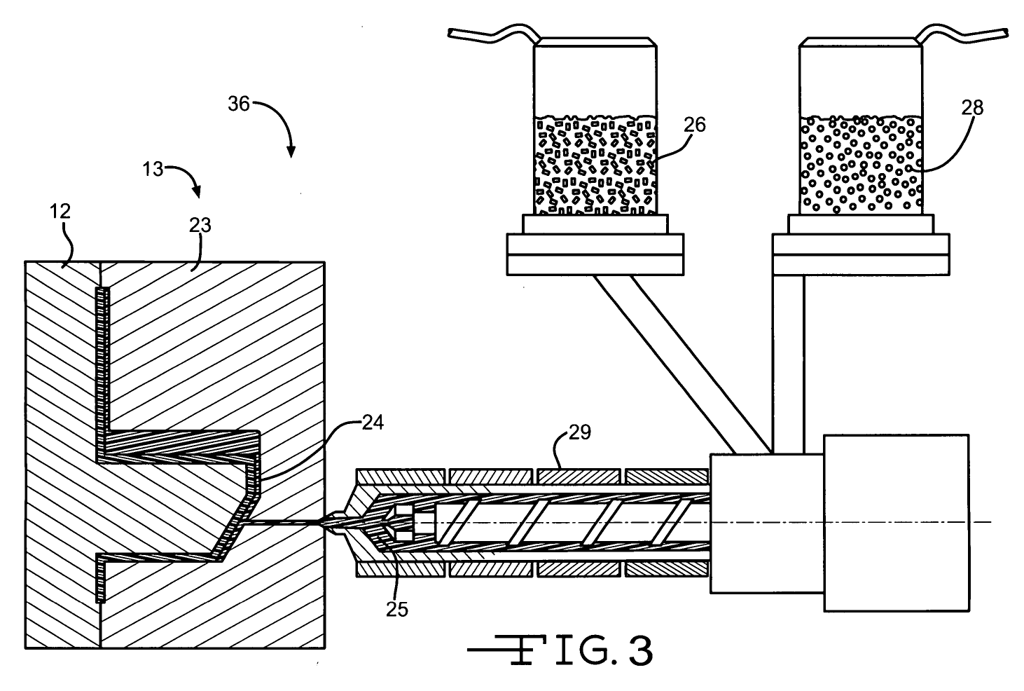

Referring to FIGS. 2 and 3, the trim component 10 is formed by an injection molding process and in accordance with the exemplary embodiment, a two shot process, wherein a mold comprising, for example, a core 12 and a first cavity 14 in a first shot of the process, provides a first space 18 therein for the introduction of a harder thermoplastic 20, which forms the substrate 42 of the trim component 10. In a second shot of the process, the core 12 is mated with a second cavity 23 to provide a second space therein, greater in size than the first space 18, for the introduction of a mixture 25 of a softer thermoplastic 26 and small expandable particles 28, and which forms the covering material 52 of the trim component 10. Preferably, the small expandable particles 28 include expandable microspheres. The microspheres are preferably microspheres sold under the name EXPANCEL ® by Kemanord A B of Stockholm, Sweden. Such microspheres comprise a copolymer shell, which encapsulates a blowing agent, such as liquid isobutane. Upon heating, the expandable microspheres expand to as much as several times their original size. The expanded cells may have a narrow particle size distribution, which may provide for a controlled and uniform cell structure in the covering material 52. The expanded cells may have a wide particle size distribution, which may provide an uneven cell structure. By using the microspheres that have a controlled size distribution, a more controlled expansion of the layer may be attained at lower temperatures. This may translate into lower energy usage during the process, and hence a cost savings.

Ideally, the barrel volume is commensurate with the size of the component part. In the exemplary embodiment of the invention, the mixture 25 is heated to a melting temperature of about 250-500° F. in the barrel 29 for a time required for the mixture 25 to pass through the barrel 29. Irregardless of the particle size distribution, the melting temperate, and the heating time, the particles 28 are preferably suitably matched to the melting temperature and heating time to regulate the expansion of the particles 28, and more particularly to cause the particles 28 to expand throughout the extent of the thermoplastic 26 yet cause the particles 28 to remain substantially unruptured or intact throughout thermoplastic 26 and on the outer surface 64 of the covering material 52. In this way, the outer surface of the covering material 52 has a substantially smooth look and feel. Therefore, the covering material 52 forms a cushiony layer which has good insulating properties. The heating also causes the covering material 52 to fuse or unite physically with the substrate 42 to form an integral unit or article. This bonding occurs because the substrate 42 is still warm when it is exposed to the mixture 25 forming the covering material 52. It thus merges with the covering material 52 such that the two layers fuse and form a unitary part.

The final step is to allow the molded trim component 10 to cool and then strip the finished trim component 10 from the mold for use, storage or packing. The smooth outer surface 64 of the covering material 52 is pleasant to the touch and sight.

Although the substrate 42 and expandable covering material 52 may both substantially comprise resins, plasticizers, and stabilizers, the two compositions may have different properties and thus have different constituents or components. If desirable, a colorant can be added and surface definition may be transferred to the outer surface 64 from the mold. Since the trim component 10 is injection molded, the covering material 52 in not stretched and thus does not lose its grain depth and definition, and does not have a glossed up, washed out surface.

The expandable particles used in the present invention preferably have a property of elastic recovery when the beads are pressed until they are deformed and then the pressure is relieved.

Examples of interior trim components 10 include but are not limited to an instrument panel, a dashboard, a handle, a gear lever knob, a door knob, an arm rest, various kinds of switches, a seat, a ceiling material, a door material, and a console box.

It will be appreciated, that in accordance with each embodiment of the invention, a first step of the method of the invention includes providing a suitable mold assembly.

A second step of the method of this invention is illustrated generally at 34 in FIG. 2. In the second step 34, a first mold assembly 11 is moved to a first closed position, as viewed in the drawing. In the first closed position, a first mold section 12 (e.g., a core) and a second mold section 14 (e.g, a first cavity) define a first space 18. A first material 20 is introduced into the first space 18. Any desired material can be introduced into the first space 18. Preferably the first material 20 is rigid plastic, most preferably a thermoplastic, such as a thermoplastic olefin (TPO), or may be formed of a glass reinforced urethane (GRU), a styrene/maleic anhydride copolymer (SMA), or a Dylark (TM) resin, manufactured by NOVA Chemicals, of Calgary, Alberta, Canada, which may be glass reinforced. The first material 20 then conforms to the shape of the first space 18, thereby forming a first trim component portion (e.g., a substrate 42). The first mold section 12 and the second mold section 14 are then moved away from one another.

A third step of the method of this invention is illustrated generally at 36 in FIG. 3. In the third step 36, the first mold section 12 and a third mold section 23 (e.g, a second cavity) are moved into contact with one another and into a second closed position, thereby forming the second mold assembly 13. In the second closed position, the first mold section 12 and the third mold section 23 define a second space 24. A second material 25 is then introduced into the second space 24. Any desired material can be introduced into the second space 24. Preferably, the second material 25 is formed from softer thermoplastic, such as thermo plastic elastomer (TPE), or thermoplastic olefin (TPO), or thermo plastic vulcanite (TPV). The second material 25 may substantially conform to the shape of the second space 24, thereby forming a second trim component portion (e.g., a skin or covering material 52). It will be appreciated that the first and second materials 20 and 25, respectively, may be of the same material. Preferably, however, the first and second materials 20 and 25 are of different materials. More preferably, the first material 20 is relatively harder than the second material 25.

Preferably, the covering material 52 becomes chemically bonded to the substrate 42 during the molding process to form the trim component 10. However, such chemical bonding is not required.

The first mold section 12 and the third mold section 23 are then moved away from one another and the trim component 10 is removed the mold assembly 13. It will be appreciated that the method of the invention can be performed with satisfactory results in a shuttle-mold wherein the second and third mold sections 14 and 23 move relative to a stationary first mold section 12. The method of the invention can also be performed with satisfactory results in a shuttle-mold wherein the first mold section 12 moves relative to stationary second and third mold sections 14 and 23, or wherein all mold sections 12, 14 and 23 move relative to one another.

Preferably, the trim component 10 is manufactured using a two-shot molding process. The two-shot molding process may be accomplished by rotating the first mold section 12, such as in a rotational molding process. In such a rotational molding process, the substrate 42 is first injection molded in the first mold assembly 11 as described herein with reference to FIG. 2. The first mold section 12, containing the substrate 42 is then rotated to a second position and joined with the third mold section 23 to form the second space 24, as shown in FIG. 3. The covering material 52 is then injection molded in the second space 24. Alternately, two separate molds could be used sequentially to form the substrate 42 and the covering material 52.

The method of forming an armrest described herein, and the armrest formed thereby, is advantageous over prior art designs because the two-shot molding process eliminates the manual assembly required by the prior art methods. The method of the invention further improves quality, and eliminates the multiple components, such as structural members or substrates, foam inserts, outer covers or skins, closure plates, and adhesives or fasteners, of known armrest assemblies.

It will be appreciated that the interior trim component 10 can be attached to the motor vehicle by any desired method. For example, threaded fasteners can be inserted through an aperture (not shown) in the interior trim component 10 and into an interior panel of the motor vehicle. Alternately, an underside or backside of the substrate 42 can include outwardly extending bosses (not shown) which define thermoplastic stakes. Such thermoplastic stakes can be extended through an aperture in the interior panel of the motor vehicle. It will be appreciated that the portion of the thermoplastic stake which extends through the interior panel of the motor vehicle may be melted and reformed, so as to mechanically bond the interior trim component 10 to the interior panel of the motor vehicle. The thermoplastic stake can be melted by any desired means, such as a heated aluminum platen (not shown).

In accordance with the method of the invention, there is formed an elastic molded body comprising a cell structure having elastic hollow microspheres in the form of thin shells that are embedded within a soft plastic material and are firmly an unseparably connected with the soft plastic material. The interior of the hollow microspheres contains a gas so as to form closed cells within the soft plastic material. The resultant covering material 52 has reduced density, and weight and cost savings.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A motor vehicle interior trim component comprising:
a substrate;
covering material injection molded onto at least a portion of the substrate, the covering material having gas-encapsulating elements therein, the gas-encapsulating elements having a property of elastic recovery when the gas-encapsulating elements are pressed until they are deformed and then the pressure is relieved.

2. The component of claim 1 wherein the substrate is formed of rigid plastic.

3. The component of claim 1 wherein the substrate is formed of a thermoplastic.

4. The component of claim 1 wherein the substrate is formed of at least one of a thermoplastic olefin (TPO), a glass reinforced urethane (GRU), a styrene/maleic anhydride copolymer (SMA), or a Dylark (TM) resin.

5. The component of claim 1 wherein the substrate is formed of a thermoplastic and the covering material is formed from a thermoplastic that is softer than substrate thermoplastic.

6. The component of claim 1 wherein the covering material is formed from at least one of a thermo plastic elastomer (TPE), a thermoplastic olefin (TPO), or a thermo plastic vulcanite (TPV).

7. The component of claim 1 wherein the covering material substantially conforms to the shape of a least a portion of the substrate.

8. The component of claim 1 wherein the covering material is provided with a textured surface definition.

9. The component of claim 1 wherein the covering material is bonded to the substrate.

10. The component of claim 1 wherein the gas-encapsulating elements comprise shells having gas therein, the gas-encapsulating elements being formed by heating the shells when injection molding the covering material to soften the shells and permit the gas to cause the softened shells to expand, the expanded shells hardening and remaining expanded when cooled.

11. The component of claim 1 wherein the gas-encapsulating elements are suitably matched to a melting temperature and a heating time to cause the elements to expand throughout the covering material while the elements are caused to remain substantially unruptured or intact throughout covering material and on an outer surface of the covering material.

12. The component of claim 1 wherein the gas-encapsulating elements are microspheres.

13. The component of claim 1 wherein the gas-encapsulating elements are Expancels.

14. The component of claim 1 wherein the covering material has a substantially smooth outer surface.

15. The component of claim 1 wherein the substrate is injection molded and the covering material is injection molded onto the substrate.

16. The component of claim 15 wherein the substrate and the covering material are injection molded by a two shot injection molding process, wherein the substrate is first injection molded in a first mold assembly and then the covering material is injection molded in a second mold assembly.

17. The component of claim 1 wherein a colorant is added to the covering material and surface definition is transferred to an outer surface of the covering material from the second mold assembly.

18. A method of forming an interior trim component comprising the steps of:
a) forming a first space in a mold and introducing a first material into the first space, the first material substantially conforming to the shape of the first space to form a substrate; and
b) forming a second space in a mold and introducing a second material into the second space, the second material substantially conforming to the shape of the second space to form a covering material over the substrate, second material being softer than the first material and having gas-encapsulating elements therein.

19. The component of claim 18 wherein the gas-encapsulating elements are microspheres.
